(19) United States
(12) Patent Application Publication
(10) Pub. No.: US 2014/0358818 A1
(43) Pub. Date: Dec. 4, 2014

(54) PRODUCT-INFORMATION MANAGEMENT DEVICE, METHOD, AND PROGRAM

(71) Applicant: Hitachi, Ltd., Tokyo (JP)

(72) Inventor: Noriyuki Haga, Tokyo (JP)

(21) Appl. No.: 14/361,374

(22) PCT Filed: Oct. 4, 2012
(86) PCT No.: PCT/JP2012/075745

§ 371 Date: May 29, 2014

(30) Foreign Application Priority Data
Nov. 30, 2011 (JP) 2011-261138

(51) Int. Cl. G06Q 10/00

(52) U.S. Cl. CPC G06Q 10/00
USPC 705/343

(57) ABSTRACT

A technique which can designate important feature information and specification item of a product and a component and can achieve effective design support (product/component information management) is provided. A present product-information management device (100) has: a specification-data storage unit (21) of storing specification data (60) containing an specification item of the product and the component and containing a specification value of the specification item; a calculation unit (11) of performing a processing of calculating specification-item relation information representing a relation among a plurality of specification items of the product and the component by using the specification data (60) and of storing the information in a storage unit (22); a display unit (12) of performing a processing of displaying the specification-item relation information on a screen for a user; and an edition unit (13) of performing a processing of editing the relation among the plurality of specification items of the specification-item relation information displayed on the screen by an input operation of the user and of updating the specification-item relation information in the storage unit and a display content of the screen in accordance with the edition.

### TECHNICAL FIELD

The present invention relates to a technique of an information processing of product information management. More particularly, the present invention relates to a product-information management device for managing data of a product or a component which have been designed or produced in the past. More particularly, the present invention relates to a technique effectively applied for support such as standardization of a product or a component by extracting a feature of the product or the component using a processing for the data of the managed product or component.

### BACKGROUND ART

As examples of conventional arts related to the product information management, Japanese Patent Application Laid-Open Publication No. 2009-288848 (Patent Document 1), Japanese Patent No. 3879673 (Patent Document 2), and others are cited.

Patent Document 1 describes as follows (see abstract). A problem to be solved is “to enable more effective and efficient component sharing design among a plurality of products”. A solution means is “to have: an information creating means 2 of defining relation information based on contents of relativity in information among a plurality of products, components configuring the products, functions achieved by the components, and characteristics of the functions, the relativity being set by a user, and registering the relation information together with the above-described information in a product-design-information etc. storage means 3; a component-sharing processing means 4 of specifying the products each containing a component desirably to be shared and creating product group information containing the products; and a component-sharing evaluating means 6 of evaluating the product group designated by the product group information and the products included in the product group in accordance with an evaluation index which has been set”.

Patent Document 2 described as follows (see abstract). A problem to be solved is that “a user who selects a standard component cannot appropriately select the standard part if the user does not know the definition of similarity well”. A solution means is a component-standardization supporting device for selecting a component suitable for the standard component from data of a plurality of components, the device having: a multidimensional database for storing multidimensional data representing attributes of the plurality of components; a production history database for storing production history data representing production volumes of the plurality of components; a vicinity-range input device for receiving input of a vicinity range value corresponding to an attribute name and creating vicinity-range data; a standard-component judging device for reading the multidimensional data stored in the multidimensional database and the production history data stored in the production history database, selecting the standard component by using the vicinity range data from the read data of the plurality of components, and outputting standard component data; and a display device for displaying the standard component data”.

### PRIOR ART DOCUMENTS

### Patent Documents

Patent Document 1: Japanese Patent Application Laid-Open Publication No. 2009-288848
Patent Document 2: Japanese Patent No. 3879673

### DISCLOSURE OF THE INVENTION

### Problems to be Solved by the Invention

In a conventional technique, a user (person) such as a designer inputs the relation information. However, the input of the relation information becomes difficult depending on a skill level of the person who inputs it. Further, it is difficult to handle it if there are many items as the relation information. It is desired to easily handle it by the user even when there are many items as the relation information.

Above-described Patent Document 1 describes the component-sharing-design supporting device which can design the component sharing of the plurality of products. However, in this device, the relation information about the functions and the features of the products and the components required for the support of the component sharing design is set by the user. Therefore, the user is required to sufficiently have design knowledge about the products and the components, and the user who does not have the knowledge is difficult to design the component sharing. Further, even if the user has the knowledge, there are a lot of the function and the feature information about the products and the components, time for designating which information is to be used from among a lot of information is required, it takes time to set the relation information by the user, and besides, it also takes time to share the component.

The above-described Patent Document 2 descries the component-standardization supporting device capable of selecting the standard component by inputting a vicinity range of the attribute of the component for judging the component standardization. However, even the vicinity ranges of the attributes of the same products or components are different from each other depending on types of the products or the parts, anyone except for only a designer who understands the designs of the products or the components and manufacturing limitations thereof cannot designate the vicinity ranges, and therefore, it is difficult to standardize the components.

In consideration of the above description, a main object of the present invention is to provide, in a technique of a product-information management device or others, a technique capable of achieving effective design support (product/component information management) so that even a person (designer) who does not sufficiently understand the design of the products and the components can designate important feature information and specification items of the products and the components and share and standardizes the components or performs others based on the feature information and the specification items.

For example, the object is to provide a technique capable of easily viewing and founding the important specification item or others (such as an important specification item to be a condition for determining the component) from among information such as a lot of specification information (specification items) of the products and the components by organizing and displaying the information by providing a predetermined graphical user interface, and besides, capable of easily extracting an item or others which largely affects on a cost by founding the important specification item or others, and capable of contributing to reduction in the product cost because the standard component or others is accurately extracted by organizing past product/component information based on the important specification item.

### Means for Solving the Problems

In order to achieve the above-described object, a typical embodiment of the present invention is a product-information management device, and has a feature having the following configuration.

The present product-information management device is a device for performing computer information processing (software program processing, etc.) of managing information of a product and a component (component part) used in the product, and has: a first means of performing a processing of storing/registering specification data containing a specification item of the product and the component and containing a specification value (specification item value) of the specification item in a storage unit; a second means of performing a processing of calculating information representing a relation among the plurality of specification items of the product and the component by using the specification data and of storing the information in a storage unit; and a third means of performing a processing of displaying the specification-item relation information on a screen for a user. Moreover, the present device has an edition unit of performing a processing of editing the relation among the plurality of specification items in the specification-item relation information displayed on the screen by an input operation of the user, and of updating the specification-item relation information in the storage unit and a display content of the screen in accordance with the edition.

The calculation unit (second means) performs a processing of calculating a relation value “a” between paired specification items as the specification-item relation information and of storing the relation value in the storage unit as relation value data, a processing of calculating an influence value “13” on the paired specification items and of storing the influence value in the storage unit as influence value data, a processing of setting a related-specification-item group in the plurality of specification items based on the relation value α, and a processing of setting a representative specification item in the related-specification-item group based on the influence value β.

### Effects of the Invention

According to the typical embodiment of the present invention, in a technique of a product-information management device or others, an effective design support (product/component information management) can be achieved so as to designate important feature information of a product or a component and a specification item thereof even by a person (designer) who does not sufficiently understand designing of the product or the component, and so as to achieve component sharing or component standardization based on the information and the item.

### BRIEF DESCRIPTIONS OF THE DRAWINGS

FIG. 1 is a diagram illustrating the entire configuration of a system (including a product-information management device) of an embodiment of the present invention;

FIG. 2 is a diagram illustrating a detailed configuration example of the product-information management device of FIG. 1 as a supplement;

FIG. 3 is a flow chart of the entire processing by the product-information management device of the present embodiment;

FIG. 4 is a flow chart of a processing (S302) of calculating a specification-item relation value (α) of FIG. 3;

FIG. 5 is a flow chart of a processing (S303) of calculating a specification-item influence value (β) of FIG. 3;

FIG. 6 is a diagram illustrating a table example of specification data (60) about products and parts;

FIG. 7 is a diagram illustrating a table example of a specification-item relation value data (70);

FIG. 8 is a diagram illustrating a table example of a specification-item influence value data (80);

FIG. 9 is a diagram illustrating a (first) screen example of display of a specification-item relation; and

FIG. 10 is a diagram illustrating a (second) screen example of display of a specification-item relation.

### BEST MODE FOR CARRYING OUT THE INVENTION

Hereinafter, an embodiment (for a product-information management device and others) of the present invention will be described in detail based on the accompanying drawings. Note that the same components are denoted by the same reference symbols in principle throughout all drawings for describing the embodiment, and the repetitive description thereof will be omitted.

[System (1)]

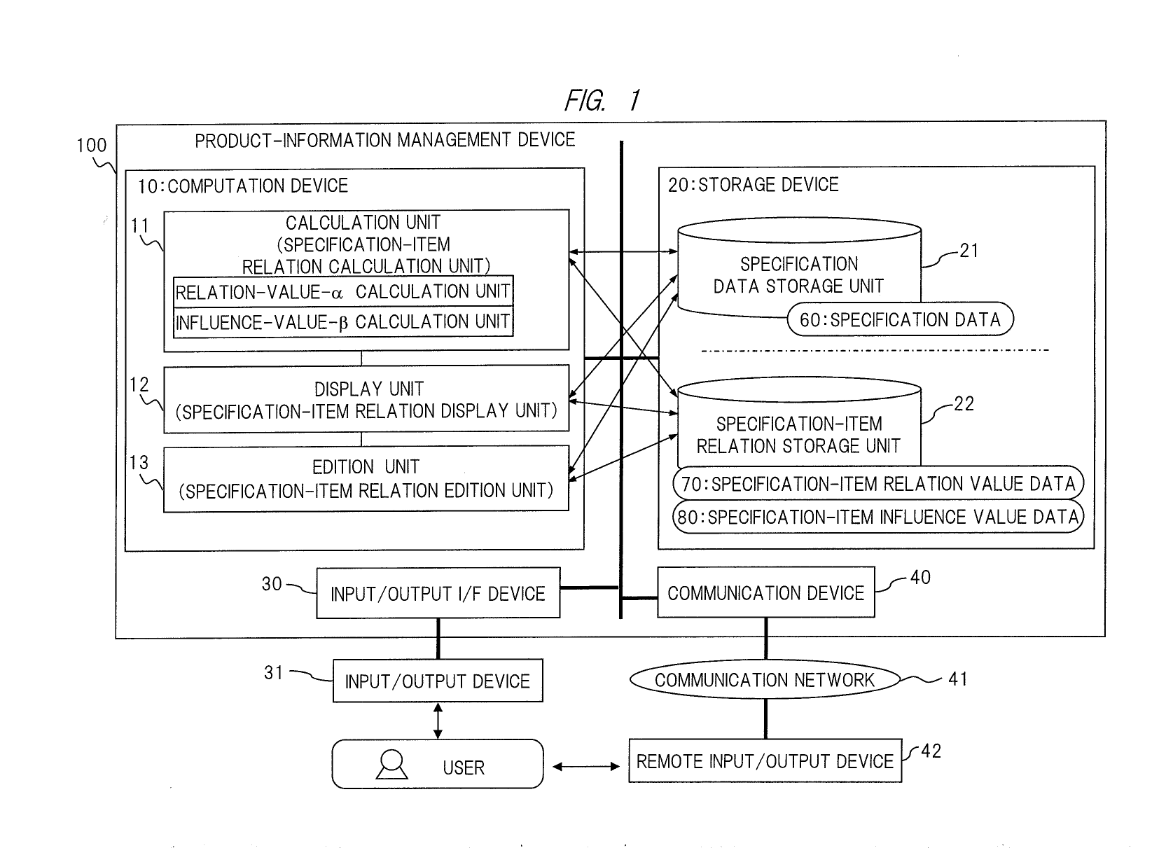

FIG. 1 illustrates a configuration example configured to include a product-information management device 100, a peripheral device, and others, which configure a system (product-information management system) of the present embodiment. The entire system has the product-information management device 100, an input/output device 31 connected to the product-information management device, and a remote input/output device 42 connected via a communication network 41. A user (product-information manager, designer, etc.) uses a function of this product-information management device 100 through operation of the input/output device 31. The product-information management device 100 can be configured of a general calculator (PC or others), and achieves this featured processing function (including each processing unit of a computation device 10) by, for example, software program processing.

The product-information management device 100 is configured of the computation device 10, a storage device 20, an input/output I/F (interface) device 30, a communication device 40, a bus, and others.

The input/output device 31 is an input device and an output device which, for example, inputs specification-value data or others and outputs relevant design information by an operation of the user, and includes, for example, a keyboard, a mouse, a display, a printer, and others. The input/output I/F device 30 is a unit which performs a processing of interface control (peripheral device control) such as data exchange with each input/output device 31. In the present system, a graphical user interface (GUI) is configured on the screen of a display (31) based on the processing of the computation device 10 and the processing of the input/output device 30 so as to display various types of information.

The communication device 40 performs a communication interface processing of connecting the present device (100) to a communication network 41. The remote input/output device 42 is used when the user can input/output data to/from the present device (100) or perform others at a remote location via the communication network 41 such as Internet or a LAN. When the remote input/output device 42 is used, a processing of data exchange or others is performed with the communication device 40 of the present device (100) via the communication network 41. For example, the present device (100) may be a Web server device, and the remote input/output device 42 may be a terminal device provided with a Web browser.

The computation device 10 is configured of a publicly-known element such as a CPU, a RAM, and a ROM. As the processing units, the computation device 10 has a calculation unit (specification-item relation calculation unit) 11, a display unit (specification-item relation display unit) 12, an edition unit (specification-item relation edit unit) 13.

Although not illustrated in the drawings, note that the present device (100) has a publicly-known element such as an OS, a middleware, and an application, and, more particularly, is provided with an existing processing function for displaying a GUI screen on the display (31) in a Web page format or others. The computation device 10 (each processing unit) uses the above-described existing processing functions for performing a processing of drawing and displaying a predetermined screen and a processing of data information inputted on the screen by the user.

The storage device 20 is configured of, for example, a publicly-known element such as a HDD or a MO, and is configured to have a storage unit including a specification-data storage unit 21 and a specification-item relation storage unit 22, or including corresponding data information (for example, database or table). Also, each of the data information, a program, etc. thereof may be acquired/referenced from outside via the communication network 41.

The specification-data storage unit 21 is a part which stores specification data 60 about a target product and a component configuring the product, and can use, for example, existing data (information managed/created by other system).

The specification-item relation storage unit 22 is a unit which stores data information processed by the featured functions of the computation device 10, and contains specification-item relation value data 70 and specification-item influence value data 80. The specification-item relation value data 70 is the data representing the relation value between the specification items of the product/component in the specification data 60 (21). The specification-item influence value data 80 is the data representing the influence value between the specification items of the product/component.

[System (2)]

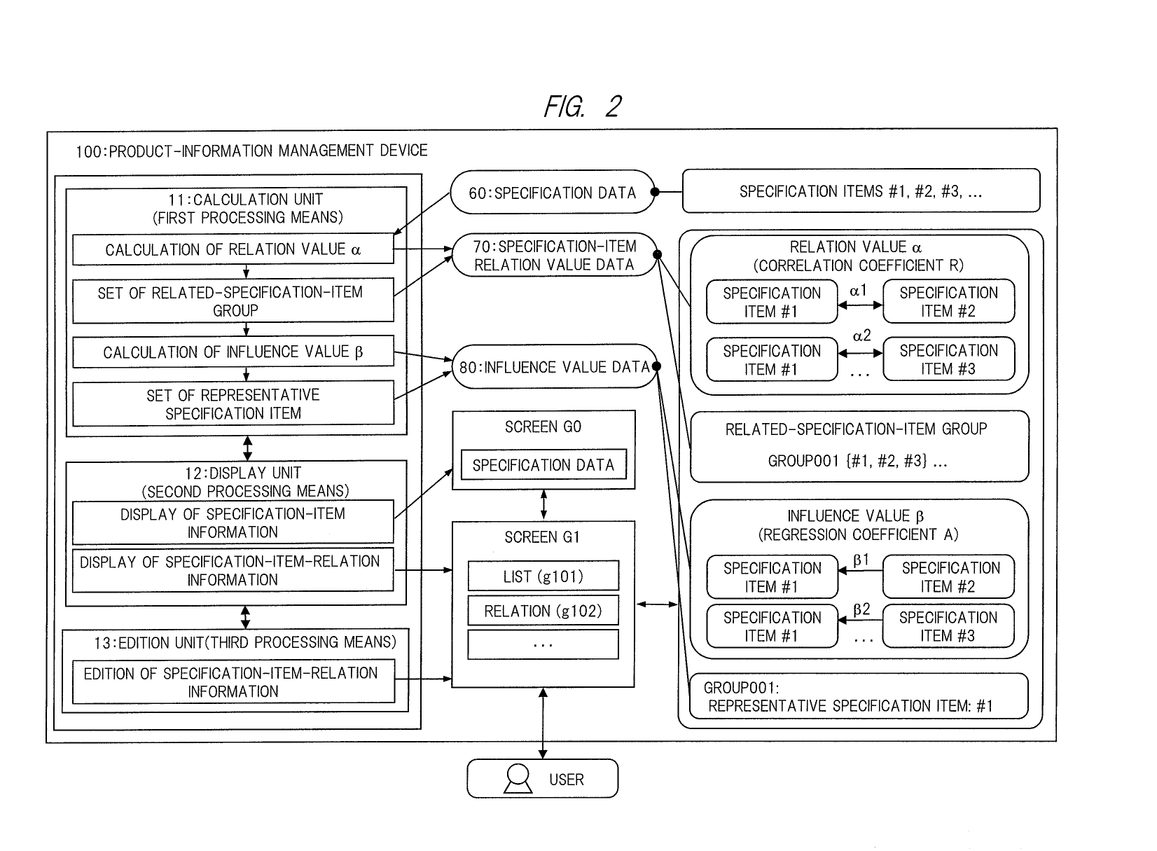

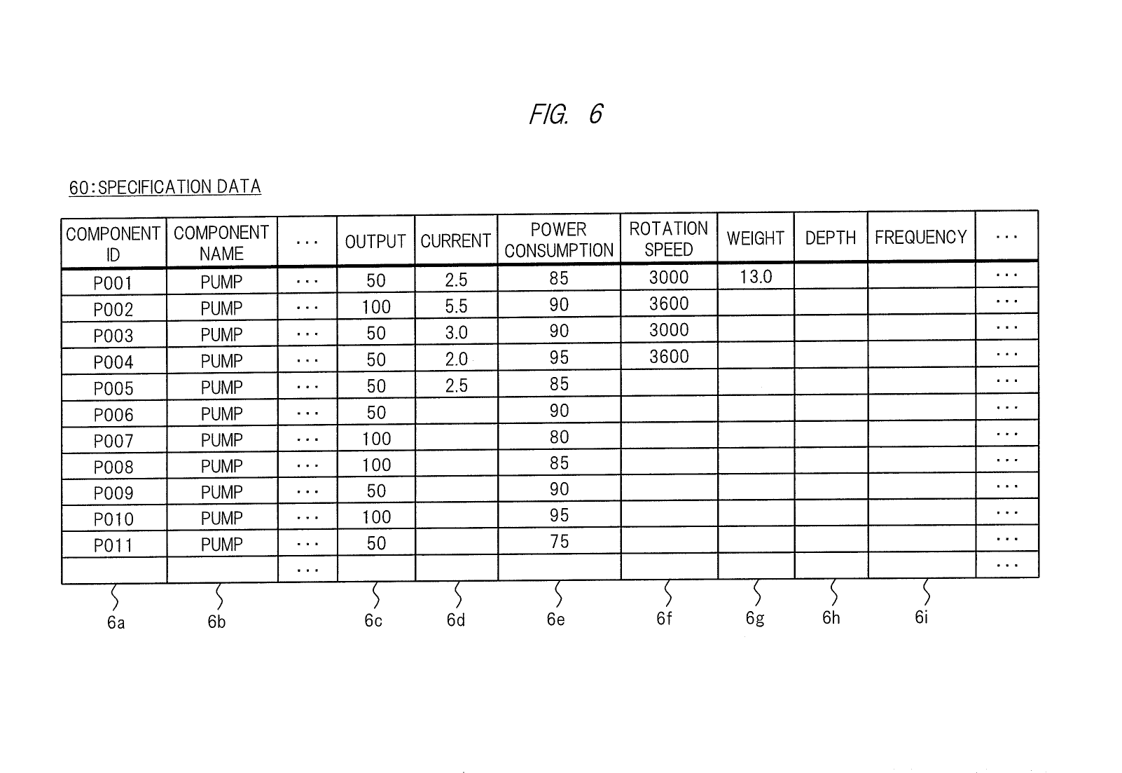

FIG. 2 illustrates a detailed configuration example of the product-information management device 100 of FIG. 1 as a supplement (corresponding processing will be described later). The calculation unit 11 includes a relation-value-α calculation processing, a related-specification-item-group setting processing, an influence-value-β calculation processing, and a representative-specification-item setting processing, etc. The display unit 12 includes a specification-item information display processing and a specification-item relation information display processing. The specification-item information display processing is a processing (conventional technique) of displaying the specification item information (product/component information) on a screen “G0” (not illustrated) by using the specification data 60. For example, a table as illustrated in FIG. 6 may be originally displayed. The specification-item relation information display processing displays the specification-item relation information (such as list information (g101), relation information (g102)) on a screen “G1” by using each piece of the data (60, 70, 80). The edition unit 13 updates the displayed contents and corresponding data information (60, 70, 80) in accordance with the edition of the information contents of the screen G1 by the user.

[Specification Data]

FIG. 6 is an example of a data table of the specification data 60 stored in the specification-data storage unit 21. On a vertical line (a row) of the table, data (records) of the product or the component which has been designed in the past are arranged. In the example of FIG. 6, component data identified by a component ID (6a) and a component name (6b) is arranged (in other words, the specification data of the component is managed). However, the example is the same as a case in which they are replaced with a product ID, a product name, etc. as the product data. As the component ID (6a), a value by which a lot of (for example, hundred to hundred-thousand order of) products/components can be uniquely identified is used.

On a horizontal line (a column), specification data items (specification items) of the component represented by the component ID (6a) are arranged in each item illustrated in 6c and the subsequent columns, and a detailed value (specification data value (specification value)) of the specification data item is stored in each record. As the specification items of the component in the example of FIG. 6, an output (6c), a current (6d), a power consumption (6e), a rotation speed (6f), a weight (6g), a depth (6h), a frequency (6i), etc are cited. For example, as the specification data of a component having a component ID=“P001” and a component name=“pump”, such value data as the output (6c)=50, the current (6d)=2.5, the power consumption (6e)=85, the rotation speed (6f)=3000, and the weight (6g)=13.0 is stored.

[Specification-Item Relation Value Data]

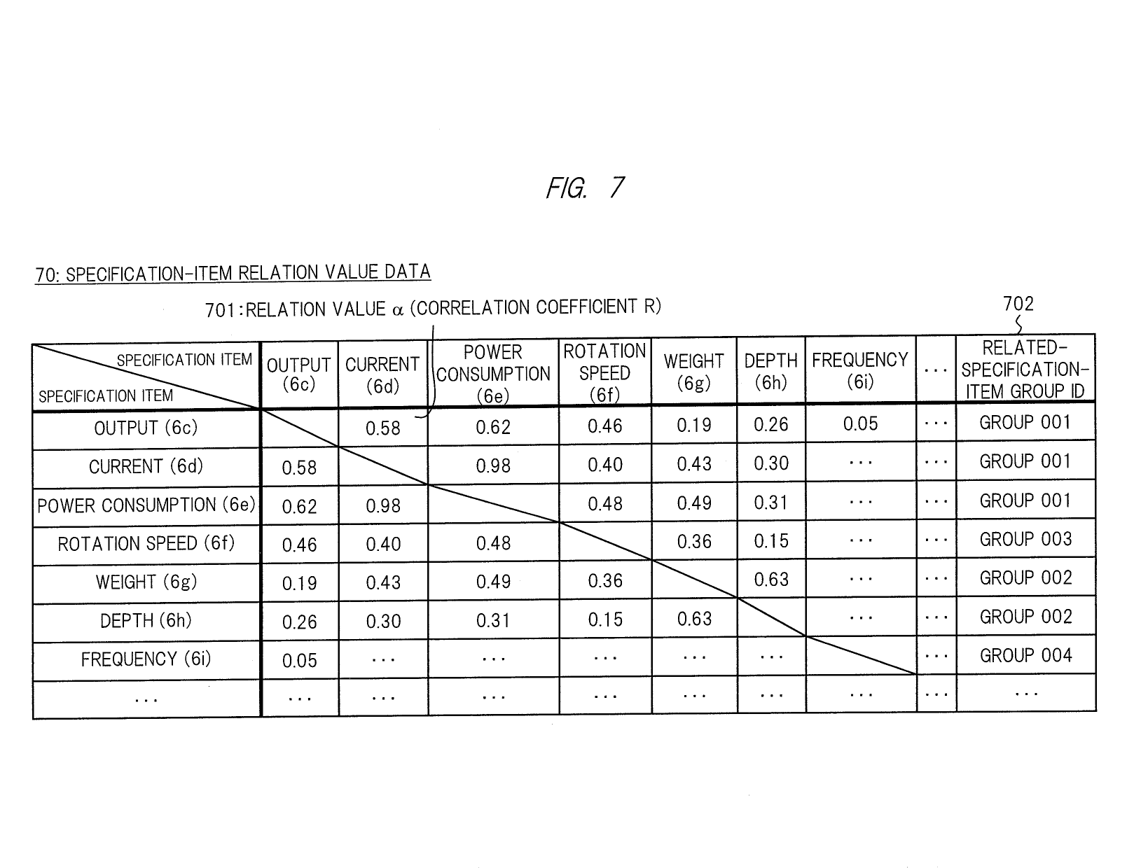

FIG. 7 illustrates a data table example of the specification-item relation value data 70 stored in the specification-item relation storage unit 22. The relation value is the information mainly related to setting (determination) of the group of the specification items. In each item on the vertical line and the horizontal line, the specification items (specification item names) (6c to 6i, etc.) illustrated in FIG. 6 (60) are listed. In each cell part at which the vertical and horizontal specification items cross each other, the relation value of both of them is stored in a form of a correlation coefficient. For the sake of explanation, it is assumed that the relation value is “a”, and that the correlation coefficient is “R”. In the present embodiment, a case of usage of the correlation coefficient R as the relation value α between the specification items will be explained.

The correlation coefficient R is a value not having a direction of the relation between the two specification items. Therefore, in the present table, the same data is registered in a diagonal direction. For example, the value (701) on the row “output” and the column “current” is 0.58, and the value on the row “current” and the column “output” is also the same value.

Also, the column data of the related-specification-item group ID (702) contained in the present table is the data (identification information) representing collection (group) of the specification items. In the present example, the ID is represented by “group 001”. For example, if the items “output”, “current”, and “power consumption” in the specification items are one collection, the specification-item-group IDs (702) for these three specification items are the same value “group 001”.

[Specification-Item Influence Value Data]

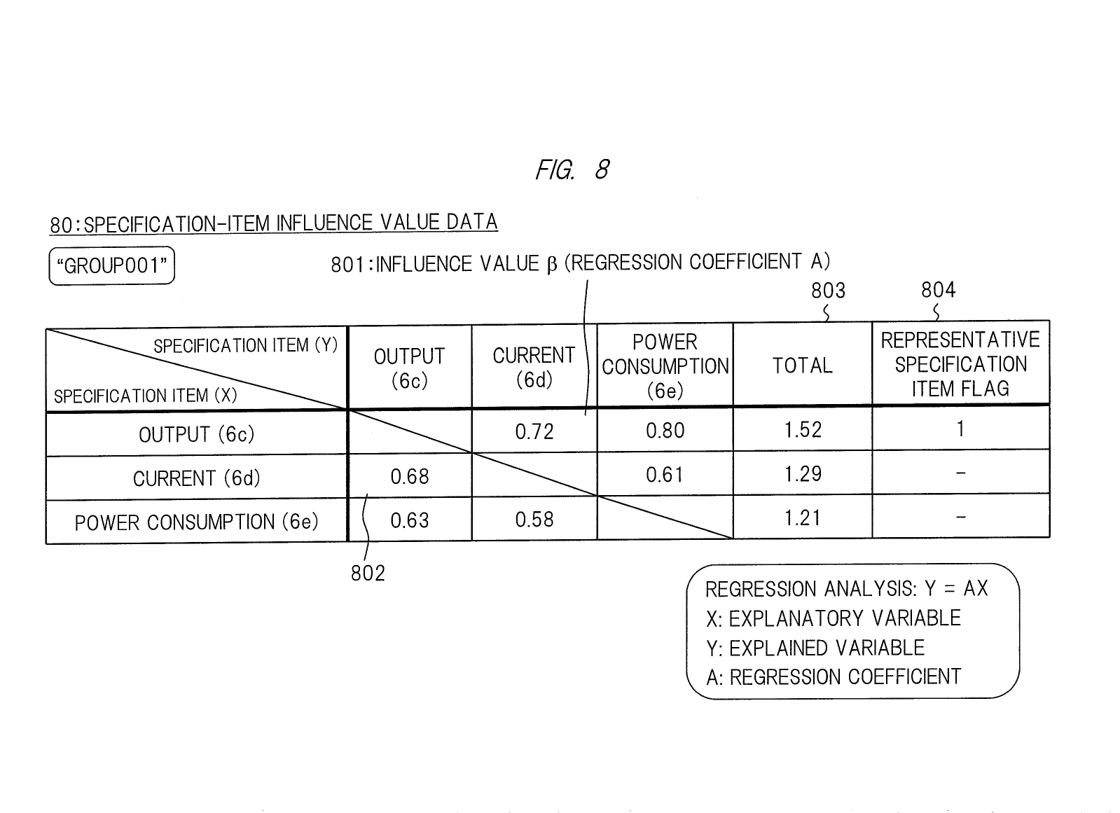

FIG. 8 illustrates a data table example of the specification-item influence value data 80 stored in the specification-item relation storage unit 22. The influence value is the information mainly related to setting (determination) of a representative of the specification items. In the present table, an influence value between the specification items in the specification item group which are related to each other in the specification items in the specification data 60 (21) is stored. The table of the present specification-item influence value data 80 is created (by the computation device 10) from (one or more) specification item(s) having the same related-specification-item group ID (702) in the table of the specification-item relation value data 70 of FIG. 7. In the example of FIG. 7, the table of the specification-item influence value data 80 as illustrated in FIG. 8 is created from, for example, the three specification items of output (6c), current (6d), and power consumption (6e) which are in the group 001 as the related-specification-item group ID (701). Similarly, the table of the specification-item influence value data 80 is created for each group ID (701).

The table of the specification-item value influence data 80 of FIG. 8 lists the specification items (specification item names) on the vertical line and the horizontal line, and basically stores an influence value in a case in which the specification item on the vertical line is an explanatory variable (X) and the specification item on the horizontal line is an explained variable (Y) in each cell (801) at which the vertical and horizontal ones cross each other. For the sake of explanation, note that the influence value is assumed to be “β”. In regression analysis: “Y=AX”, it is assumed that “X” is the explanatory variable, “Y” is the explained variable (objective variable), and “A” is a regression coefficient. The influence value β in the present embodiment is a value which represents a degree by which the value of the specification item of the explanatory variable X affects the determination of the value of the specification item of the explained variable Y. In the present embodiment, as an example, a configuration using the regression coefficient A as the influence value β will be explained.

In the data of FIG. 8, for example, “the value of the regression coefficient A=0.72” in a case in which the item “output” (6c) is the explanatory variable X and the item “current” (6d) is the explained variable Y is stored as the influence value β (801) on a cell at which the row “output” and the column “current” cross each other. Also, “the value of the regression coefficient A=0.68” in a converse case in which the item “current” (6d) is the explanatory variable X and the item “output” (6c) is the explained variable Y is stored as the influence value β (802). As different from the table of FIG. 7, the diagonally-registered values are not always matched with each other.

Further, a column “total” (803) in the table of FIG. 8 stores a value obtained by totalizing the influence values β of the specification items which are the explanatory variables X of this row. For example, in the row “output”, the value 1.52 which is the total of the value 0.72 of the column “current” and the value 0.80 of the column “power consumption” is stored in the total column (803).

Still further, in a column “representative specification item flag” (804) in the table of FIG. 8, a value “1” is stored in the specification item which becomes a representative among the specification items stored in the present table. In the example of FIG. 8, the value of the representative specification item flag (804) is 1 in the row “output”, and the flag value is not stored in the other rows (current and power consumption), and therefore, these values indicate that the specification item “output” (6c) is the representative specification item.

In the table of one specification-item influence value data 80 in the present embodiment, note that only one specification item is set as the representative by setting “1” in the representative specification item flag (804). However, as another aspect, two or more specification items can be set as the representative (1).

[Computation Device]

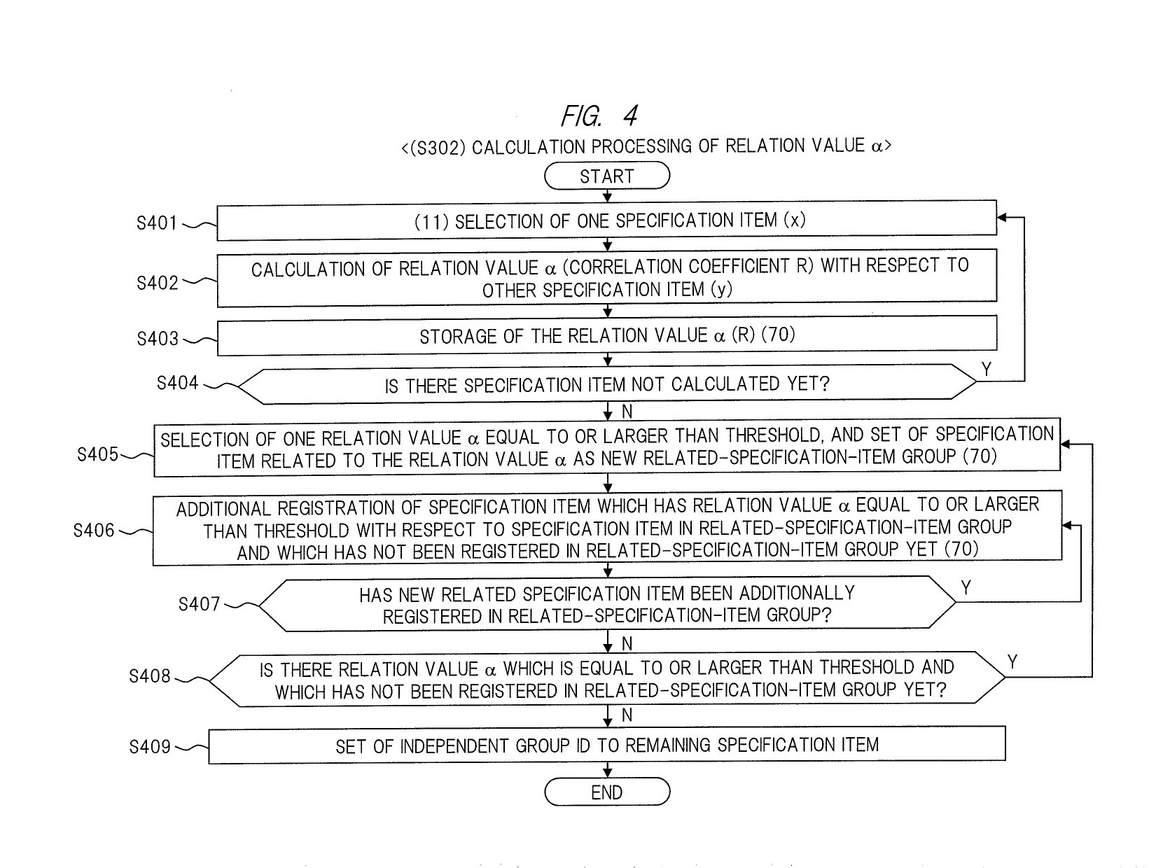

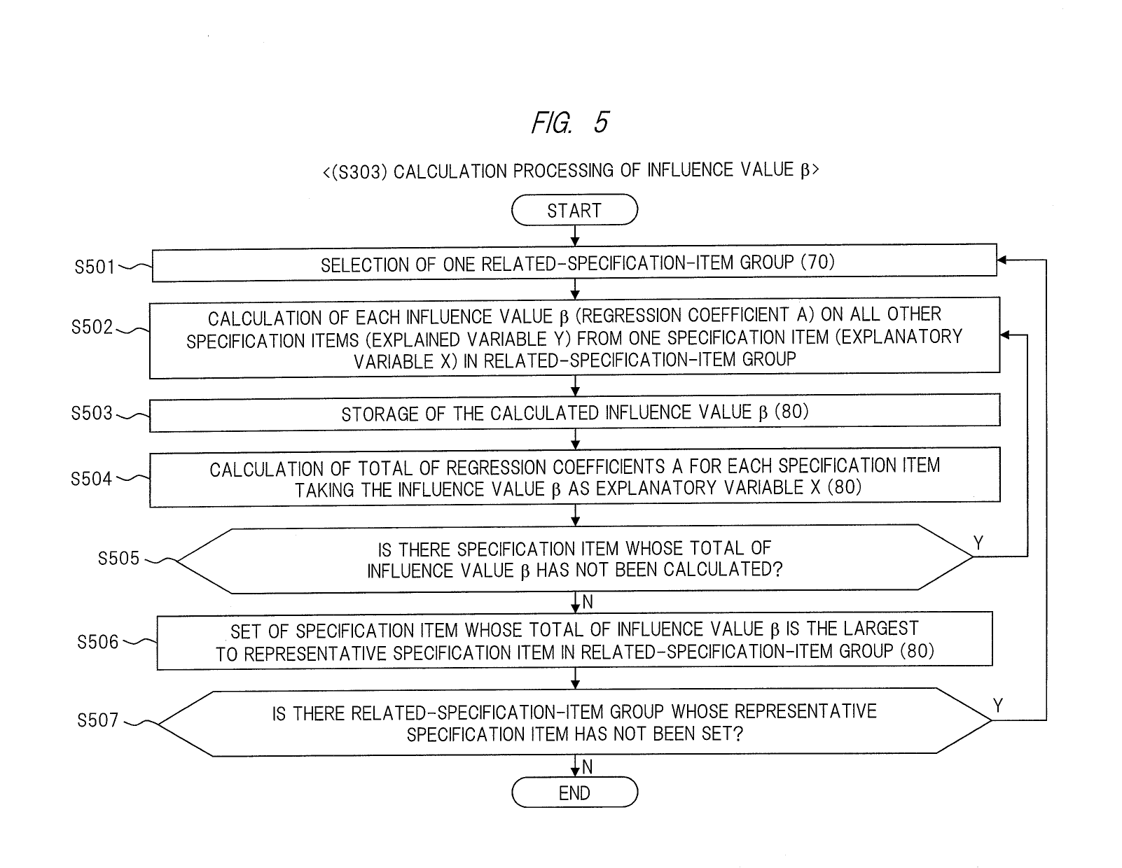

Each processing unit of the computation device 10 will be explained with returning to FIG. 1. The calculation unit (specification-item relation calculation unit) 11 retrieves the specification data 60 (FIG. 6) stored in the specification-data storage unit 21, and performs a processing of calculating the relation value α (correlation coefficient R) between the specification items and the influence value β (regression coefficient A) therebetween (has a relation-value-α calculation unit and an influence-value-β calculation unit). Then, the calculation unit 11 stores the calculated data (70) of the relation value α and the calculated data (80) of the influence value β in the specification-item relation storage units 22 (70, 80) (FIGS. 7 and 8). FIGS. 4 and 5 illustrate processing contents (described later) of the calculation unit 11 (the relation-value-α calculation unit, the influence-value-β calculation unit).

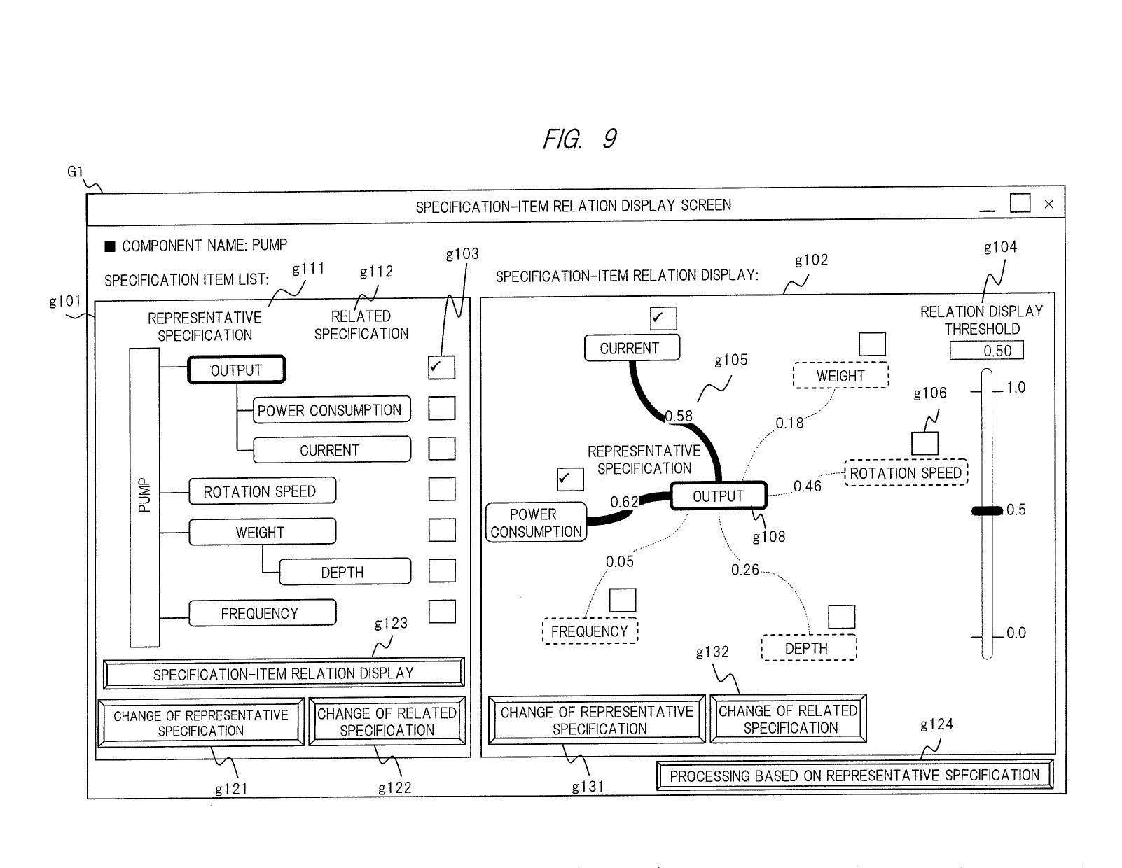

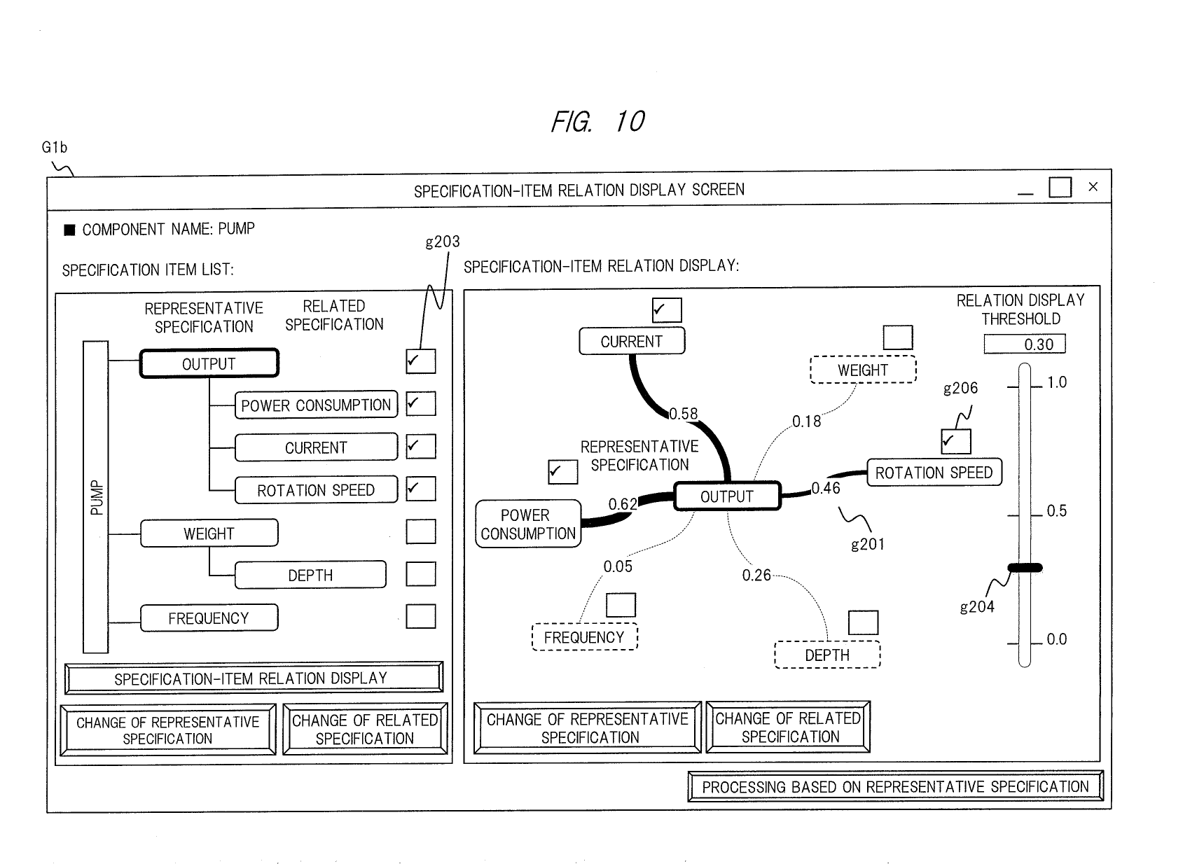

The display unit (specification-item relation display unit) 12 performs a processing of displaying the relation among the (plurality of) specification items on the screen by using the relation value α between the specification items, the related-specification-item group ID (702), and the representative specification item flag (804) in the data (70, 80) stored in the specification-item relation storage unit 22. FIGS. 9 and 10 illustrate one example of the display screen of the display unit 12 (described later).

[Processing]

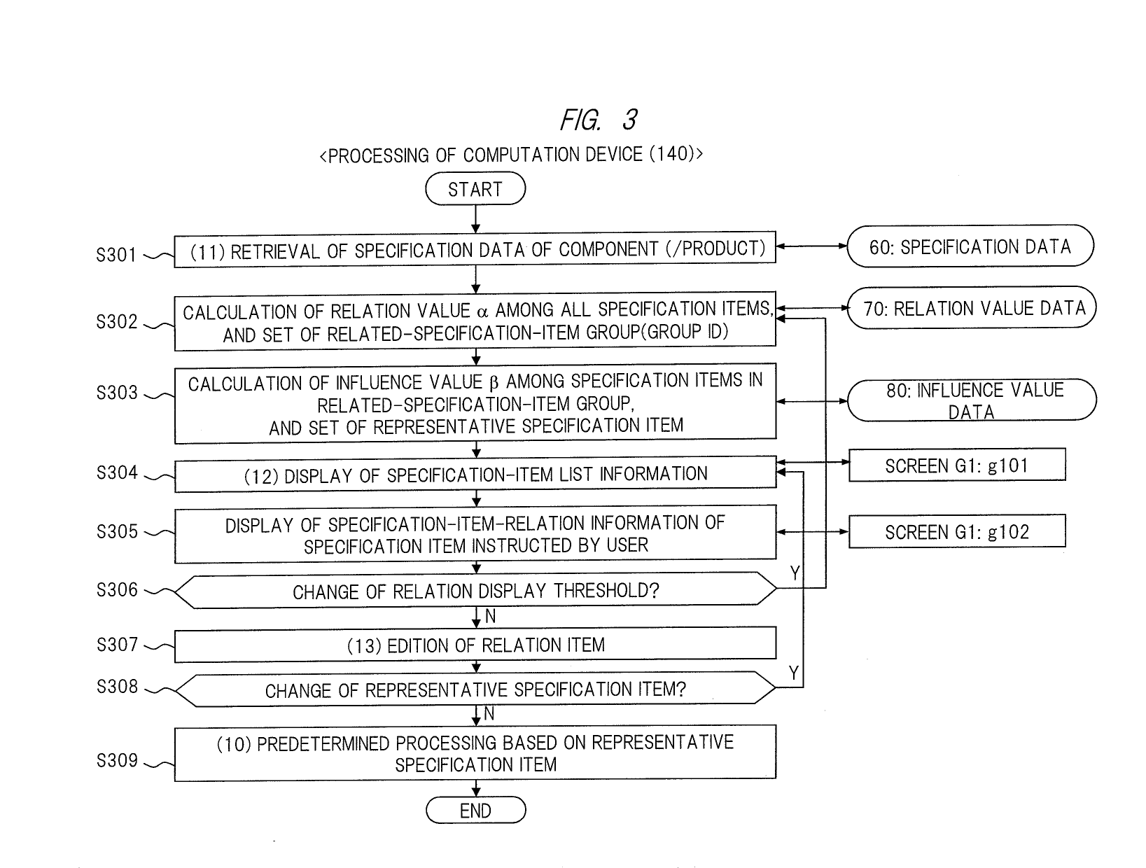

FIG. 3 illustrates the entire operation/processing by the product-information management device 100 (computation device 10) of the present embodiment (a symbol “S” represents a processing step).

(S301) The specification-item relation calculation unit 11 retrieves the specification data (the specification item and the specification value of the specification item) of the component (or the product) to be a processing target from the specification data 60 stored in the specification-data storage unit 21.

(S302) The calculation unit 11 (more particularly, the relation-value-α calculation unit) calculates the relation value α (correlation coefficient R) between the specification items of all the above-described retrieved specification data, and sets the related specification-item group (group ID) (702) related to the specification items (the relation value α). The data calculated in S302 is stored in the specification-item relation value data 70 of the specification-item relation storage unit 22. Details are illustrated in FIG. 4.

(S303) The calculation unit 11 (more particularly, the influence-value-β calculation unit) calculates the influence value β between the specification items in the related specification-item group (702) which has been set in the above-described S302, and sets (determines) the representative specification item (flag) (804) from the specification items in the related specification-item group based on the influence value β. The data calculated in S303 is stored in the specification-item influence value data 80 of the specification-item relation storage unit 22. Details are illustrated in FIG. 5.

(S304) Then, the specification-item relation display unit 12 performs a processing of retrieving the specification-item relation value data 70, etc. stored in the specification-item relation storage unit 22 and of displaying information such as a list of the related specification items on the screen (31). A specification item list (g101) on a left side of the screen G1 of FIG. 9 is a display example of the list. For example, the plurality of specification items are displayed in a tree form in accordance with relations such as representative specification items (gill) and related specification items (g112), state display and selective designation can be operated by a check box (g103) or others, and each processing can be instructed by buttons (g121 to g123).

(S305) The display unit 12 performs a processing of receiving input which instructs any of the specification items displayed on the above-described screen G1 (g101) made by a user, and of displaying the specification item relation information of the instructed (designated) specification item. The specification-item relation display (g102) on a right side of the screen G1 is a display example of the display. The above-described instruction input is achieved by such various GUI means as checking the check box, pressing the button, clicking the specification item, selection from a menu not illustrated, entering a character to an input form, or others.

(S306) The display unit 12 receives change (correction) of a relation-display threshold (threshold for displaying the highly-related specification items) which has been changed (corrected) by the user. For example, the threshold can be changed by operating a slide bar of the relation-display threshold (g104) in “g102” of the screen G1. When the display unit 12 receives the change of the threshold, the processing of the display unit 12 returns to the step S302, calculates the specification-item relation value α (again) in accordance with the changed threshold, updates the contents of the specification-item relation value data 70 of the storage unit (22) by using the calculated value, and displays the screen (G1) again by using the display unit 12 so as to provide the updated contents.

(S307) Then, when the specification-item relation edition unit 13 stands by for changing (correcting) the specification item relation by the user on the screen (31) (G1) displayed by the above-described display unit 12 followed by receiving the change, the specification-item-relation edition unit 13 updates the data (70, 80) in the specification-item relation storage unit 22 based on the changed data. For example, it receives checking for (designation to) a target specification item to be newly added as the relation specification item. Also, for example, it receives checking for (designation to) a target specification item to be eliminated from the related specification items. Further, for example, it receives checking for (designation to) a specification item to be changed as the representative specification item.

(S308) (Y) When the edition unit 13 updates the data (70, 80) of the specification-item relation storage unit 22 based on the change of the representative specification item or others, the processing returns to S304, and the screen (G1) is displayed again by the display unit 12 so as to provide the changed contents.

(S309) When all of the representative specification item targets have been checked/corrected by the user based on the above-described processing/operations, execution of a predetermined processing using the representative specification items is received by a user operation. As an example of the predetermined processing, a processing of extracting the standard component, a processing of extracting the specification item which affects the component cost, and others (publicly-known techniques) are cited.

The processing of extracting the standard component can be utilized for the processing of checking a frequency distribution of the value of the representative specification item of the component from a use history of the component in the past, and of extracting the component having the high-frequency specification value, which is the frequently-used component, as the standard component. Similarly, the processing is used for a processing of extracting the specification item having a high correlation with the cost by calculating the correlation between the cost and the representative specification item of the component from the use history of the component in the past.

[Screen]

An example of the GUI screen displayed in S304, S305, etc. by the above-described display unit 12 and the edition unit 13 will be explained by using FIGS. 9 and 10. FIG. 9 illustrates the specification-item relation display screen G1 (a state in which the above-described specification item list (g101) and the specification item relation (g102) are displayed), and a screen G1b of FIG. 10 illustrates a state obtained after the relation between the specification items is changed from the state of the screen G1 of FIG. 9 and the data is updated by the user operations. The display unit 12 creates the contents of this screen (G1) for each target product/component. In the example of the screen G1, the display of the information of the component “pump” is exemplified. The display unit 12 displays the “specification item list” (g101) for the component “pump” on the left-side region of the screen G1 by using the specification data 60 stored in the specification-data storage unit 21, the specification-item relation value data 70 stored in the specification-item relation storage unit 22, and the specification-item influence value data 80 (in the above-described S304).

In the specification item list display (g101) on the screen G1 of FIG. 9, for example, the component “pump” is put on the highest-level node, a node of each specification item (representative specification item) which is dependent on (related to) the pump is connected to the pump by a line so as to be illustrated in a tree form (g111), and besides, each specification item (related specification) (the specification item except for the representative specification item in the same group) which is dependent (related) also as a lower-level node of each specification item (representative specification item) is connected by a line so as to be displayed in a tree form (g112).

The display unit 12 displays the collection of the specification items in the above-described tree form by using the specification-item-group ID (702) of the specification-item relation value data 70. Also, the representative specification item on an upper level in view of the display is displayed by using the representative-specification-item flag (804) of the specification-item influence value data 80 (gill). From the example of the data (70) of FIG. 7, the three specification items “output”, “current”, and “power consumption” each having the (same) “group 001” as the related-specification-item group ID (702) are collected and displayed in the tree form as illustrated in the drawing. Also, from the example of the data (80) of the “group 001” of FIG. 8, since the representative specification item is the item “output” based on the flag (804), the display is made so that the item “output” is on an upper level (put as the representative) and so that the items “power consumption” and “current” are on a lower level (put as the related one). Further, for example, the related specification items (g112) are displayed in, for example, a descending order of the relation value α.

Still further, for each specification item, the display part (GUI component) on which the selection/specification operations can be performed by the user such as the check box (g103) is provided. When the user selects (checks) this part (g103) followed by pressing the “specification item relation display” button (g123), the display unit 12 displays the specification-item relation display information (g102) in accordance with the selected specification item (such as the item “output”) on a right-side region of the screen G1 so as to correspond to the contents of the left-side region (g101) (in the above-described step S305). That is, the relation between the plurality of specification items is displayed graphically (in a network (map) form in the present example) in detail.

For example, in the state of the display (g102) of the relation between the specification items of G1, the node of the representative specification item “output” (g108) is displayed to be emphasized at the center, and the nodes of the specification items “current”, “power consumption”, “the rotation speed”, “weight”, “depth”, and “frequency” are displayed around the representative specification item, and a relation between the item “output” and each specification item is displayed by a link line (g105 or others) for both of them in accordance with the data (70) of the relation value α. The link (g105 or others) is displayed so as to change in a thickness, a color, or others in accordance with the relation value α, the relation-display threshold (g104), or others. The relation-display threshold (g104) can be variably set by, for example, a user in a form of a slide bar. In the G1 state, the threshold is 0.50. In the G1b state of FIG. 10, the specification items “current” and “power consumption” having a relation of “α≧0.5” (the respective relation values α=0.58 and 0.62) are displayed by thick link lines, and the corresponding check boxes of the specification items are displayed so as to be checked. The link line of the specification item having a small relation value α is not displayed or displayed with a broken line or others.

Also in g102, the check box or others (g106 or others) which can selected/designated by the user is provided for each specification item as similar to g103. Moreover, a “representative specification change” button (g131), a “related specification change” button (g132), etc. are provided so that a corresponding processing can be designated and executed by the user.

A case in which the related specification item, etc. is automatically changed and displayed by changing the threshold (g104) in the G1 state (g102) (in the above-described S306) is as, for example, follows. Note that the display contents may be dynamically updated, or it may be required to press the “related specification change” button (g132). For example, a state of “the screen G1 having the threshold=0.50” is changed to a state of “the screen G1b having the threshold=0.30”. Then, since “the relation value α between the item “output” and the item “the rotation speed”=0.46” in the data (70) of FIG. 7, a relation of “the threshold=0.30 or larger” is established. Accordingly, the display unit 12 newly displays the relation between the item “output” and the item “the rotation speed” is displayed so as to emphasize the link as illustrated in g201. And, when the user accepts this new addition of “the rotation speed” as the related specification item, the user checks the check box (g206) for this “rotation speed”, and presses the “related specification change” button (g132). Then, to the data (70, 80) of the specification-item relation storage unit 22, the edition unit 13 reflects the change of the designated specification item “the rotation speed” into a related specification item with respect to the representative specification item “output” (g108). In the example of the specification-item relation value data 70 of FIG. 7, the edition unit 13 corrects the related-specification-item group ID (702) of the specification item “the rotation speed” from the “group 003” to the “group 001”. Also, in the example of the specification-item influence value data 80 related to the group 001 of FIG. 8, a row and a column for the specification item “the rotation speed” are added. After the above-described processing, such a content as the screen G1b (g201) is provided. In accordance with the content of g102 on the right side, the content of g101 on the left side is also updated as the content g203. The checking state of each specification item indicates that the user selects (accepts) the specification item as the related specification item.

A case of the change of the representative specification item in the G1 state (g101) by the user is as, for example, follows. For example, the user selects the check box (g103) for not the current representative specification item “output” but the item “the power consumption” as a specification item which is desirably newly set as the representative specification item, and then, presses the “representative specification change” button (g121). Then, the processing of changing the representative-specification-item flag (804) is executed to the data (80) of the influence value β by the display unit 12 and the edition unit 13, and then, the content of g101 is updated. That is, the item “power consumption” is displayed on a higher level (g111), and the item “output” is displayed on a lower level (g123). Also in g102, the change can be achieved by selecting the node of the specification item and using the “representative specification change” button (g131).

Also, when the related specification item is changed by the user in G1 (g101), for example, the user performs an operation of checking the check box (g103) for the specification item which is desirably newly added as the related specification item or of un-checking the check box (g103) for the specification item which is desirably removed from the related items in the same group, and the user presses the “related specification change” button (g122). Then, the a processing of changing the related-specification-item group ID (702) is executed to the data (70) of the relation value a by the display unit 12 and the edition unit 13, and then, the content of g101 is updated. The change may be similarly achieved by not only the above-described operation of the check box but also such an operation as executing a command by selecting the node of the desired specification item by the user, as dragging the node of the desired specification item to a desired position, or as selecting a node (s) for one or more specification items and setting them to the related-specification-item group.

As described above, based on the management data (60, 70, 80), the relation between the plurality of specification items (the related specification items or the representative specification items) can be understandably flexibly changed on the GUI screen (G1) by the user operation.

Also, by pressing the “processing based on the representative specification” button (g124) by the user on the above-described screen G1, the processing of the computation device 10 transits to a predetermined processing based on the representative specification item at that moment. The predetermined processing based on the representative specification item is, for example, a processing of the component sharing or the extraction of the standard component.

[Processing (11, α, S302)]

FIG. 4 illustrates a processing example of the specification-item relation value calculation in the above-described S302 by the specification-item relation calculation unit 11 (more particularly, the relation-value-a calculation unit).

(S401) The calculation unit 11 selects one specification item (assumed to be “x”) from among the specification items retrieved in the above-described S301.

(S402) The relation value α between the above-described selected specification item (x) and another specification item (assumed to be “y”) is calculated. In the present embodiment, as the relation value α, the correlation coefficient R expressed in the following Expression 1 is calculated.

$$\begin{matrix}[ Formula 1 ] & \\ R = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}} & ( Expression 1 )\end{matrix}$$

In the Expression 1, a term “xi” is a value of one specification item, and a term “yi” is a value of another specification item. An index “i” is variable from 1 to “n”. Symbols “x” and “y” each with an over-bar represent an average value of {xi} and an average value of {yi}, respectively. The correlation coefficient R is calculated by combinations of all the specification items whose indexes “i” are changed.

(S403) The above-described calculated relation value α (R) is stored in the corresponding cell (701) of the specification-item relation value data 70 of the specification-item relation storage unit 22 (FIG. 7).

(S404) If there is a combination of the specification items for which the above-described relation value α has not been calculated yet among the processing targets, the processing returns to S401 so as to select a combination of other specification items and similarly calculate and store the relation value α in the step S402 and the subsequent steps. When the calculation of the relation value α for all the target specification items (combinations) ends, the processing proceeds to S405.

(S405) One relation value α (R) which is equal to or larger than a certain threshold (relation-display threshold) in the above-described calculation result is selected. And, a specification item related to this relation value α is set as a new related-specification-item group. In the example of FIG. 7, when the above-described threshold (relation-display threshold) is set to 0.5, for example, the relation value (701) of the row “output” and the column “current” is 0.58 which is larger than the threshold, and therefore, “this relation value α=0.58” is selected. Then, the value of the related-specification-item group ID (702) is set (for example, group 001) as setting the specification items (“output” and “current”) related to “the relation value α=0.58” as the related-specification-item group.

(S406) Further, a specification item whose relation value α with respect to the specification item in the related-specification-item group is equal to or larger than the threshold and which has not been registered in the related-specification-item group yet is searched, and the specification item is additionally registered in the related-specification-item group. For example, when the relation value α which is equal to or larger than the threshold of the specification item related to the item “output” and the item “current” which correspond to “the above-described α=0.58” is searched, the relation value α between the item “output” and the item “power consumption” is 0.62 which is larger than the threshold (0.50), and therefore, the specification item “power consumption” is also registered in the same group ID (group 001) as the same related-specification-item group.

(S407) When the new related specification item is additionally registered in the above-described related-specification-item group (Y), the processing returns to S406 to similarly search another related specification item, and the specification item is additionally registered. For example, when the item “power consumption” is added as the new related-specification-item group, the processing returns to S406 to search the specification item having the relation value α related to the item “power consumption” equal to or larger than the threshold, and, as a result, for example, there is no new addition to the specification item group because any specification item except for the item “current” is not found, and therefore, the processing proceeds to next S408.

(S408) The specification item which has not been registered in the above-described related-specification-item group and whose relation value α is equal to or larger than the threshold is searched. If the specification item is found (Y), the processing returns to S405. For example, the relation value α between the specification items “weight” and “depth” is found as being equal to or larger than the threshold, and therefore, the processing returns to S405, a new related-specification-item group ID (group 002) is set, and the processing is similarly performed in S405 and the subsequent steps.

(S409) Finally, for the remaining specification items each not having the relation value α equal to or larger than the above-described threshold among all the specification items of the processing targets, each group ID (702) different from the registered values is set, and the processing ends. For example, in the example of FIG. 7, “group 003” is set for the specification item “rotation speed”, and “group 004” is set for the specification item “frequency”.

[Processing (11, β, S303)]

FIG. 5 illustrates a calculation processing of the specification-item influence value in the above-described S303 by the specification-item relation calculation unit 11 (more particularly, the influence-value-β calculation unit).

(S501) The calculation unit 11 selects one related-specification-item group (group ID) from the specification-item relation value data 70 of FIG. 7. For example, it is assumed that the group 001 is selected.

(S502) By regression analysis with selection of one specification item (for example, “output”) as being the explanatory variable X from the related-specification-item group selected as described above and selection of another specification item (for example, “current” or “power consumption”) as being the explained variable Y, the influence value β on the specification item of the explained variable Y from the specification item of the explanatory variable X is calculated. For example, a regression coefficient A in the case of X: “output” and Y: “current” and a regression coefficient A in the case of X: “output” and Y: “power consumption” are calculated as the influence value β. The regression coefficient A is calculated by the following Expression 2.

$$\begin{matrix}[ Formula 2 ] & \\ R = \frac{{\sum }_{i = 1}^{n} ( {x}_{i} - \overline{x} ) ( {y}_{i} - \overline{y} )}{{\sum }_{i = 1}^{n} {( {x}_{i} - \overline{x} )}^{2}} & ( Expression 2 )\end{matrix}$$

In the Expression 2, a term “xi” is set to the explanatory variable X, and a term “yi” is set to the explained variable Y. Symbols “x” and “y” each with an over-bar represent an average value of {xi} and an average value of {yi}, respectively. Note that the meanings of the symbols are different from those of the Expression 1.

For example, the regression coefficient A is calculated by using the specification value of the item “output” taking the term “xi” of the Expression 2 as the explanatory variable X and the specification value of the item “current” taking the term “yi” thereof as the explained variable Y. Similarly, the regression coefficient A in a case taking the item “power consumption” as the explained variable Y is calculated.

(S503) The calculation unit 11 registers the above-described calculated influence value β in the specification-item influence value data 80 of the specification-item relation storage unit 22 (FIG. 8).

(S504) The total of the regression coefficients A is calculated for each specification item each taking the above-described influence value β as the explanatory variable X. For example, the total of the regression coefficients A in a case taking the specification item “output” as X is calculated, and is registered in the specification-item influence value data 80 of the specification-item relation storage unit 22. For example, in the case of the item “output”, the regression coefficient A with respect to the item “current” is 0.72, and the regression coefficient A with respect to the item “power consumption” is 0.80, and therefore, the total 1.52 of them is registered in a section of the total (803) as illustrated in the example of FIG. 8.

(S505) If a specification item for which the total of the above-described influence value β has not been calculated is found (Y), the processing returns to S502, and the processing is similarly performed. For example, the items “current” and “power consumption” whose influence values β have not been calculated as the explanatory variables X, the processing returns to S502, and the influence values β are similarly calculated.

(S506) When all the influence values β in the related-specification-item group are calculated by the above-described processing to calculate the total of the regression coefficients A of each explanatory variable X, the specification item having the largest total value is set in the data (80) as the representative specification item of the related-specification-item group. For example, as illustrated in FIG. 8, all the influence values β in the group 001 are calculated, the total (803) of each explanatory variable X is calculated, and then, “1” is set to the representative-specification-item flag (804) of the specification item having the explanatory variable X as the largest total value. In the example of FIG. 8, “the flag=1” is set to the specification item “output” having the largest total of 1.52 so as to be the representative specification item.

(S507) If a specification item to which the representative specification item has not been set is found (Y) in another related-specification-item group, the processing returns to S501, and the processing is similarly repeated for this specification item group.

[Effects or Others]

As described above, according to the system (product-information management device 100) of the present embodiment, even by a user (designer) who does not sufficiently understand the design of the product and the component, the important feature information and specification item of the product and the component can be specified by providing the GUI screen (G1) by using the data (70, 80) related to the specification item in the computation device 10, and effective design support (product/component information management) can be achieved so that the component sharing, standardization, etc. can be executed based on the specification of the important feature information and specification item.

By the automatic processing by using the present product-information management device 100 (computation device 10), the representative specification item and the related specification item can be easily set in accordance with the specification item of the product/component registered as the specification data 60 and the data of the specification value of the specification item. A lot of pieces of specification information (specification items) or others related to the product and the component can be organized and understandably displayed on the screen G1, so that the important specification item or others (such as an important specification item to be a condition for determination of the standard component) can be easily found from the specification items. By determining the representative specification item followed by performing a predetermined processing using the representative specification item (in the above-described S309), the standard component or others for the products and the components can be easily extracted, and the important specification item having large influence on the cost or others can be easily extracted. The standard component or others can be accurately extracted by organizing the product/component information in the past using the important specification item or others, so that an order of the standard component, design thereof, production thereof, maintenance thereof, etc. can be executed, and this execution contributes to reduction in the cost, the shortening of lead time, etc.

In the foregoing, the invention made by the present inventor has been concretely described based on the embodiment. However, it is needless to say that the present invention is not limited to the foregoing embodiment and various modifications and alterations can be made within the scope of the present invention.

### INDUSTRIAL APPLICABILITY

The present invention can be used for a product management system, a SCM, an EDI, and others.

1. A product-information management device for managing information of a product and a component comprising:
a specification data storage unit of storing specification data containing a specification item of the product and the component and containing a specification value of the specification item;
a calculation unit of performing a processing of calculating specification-item relation information representing a relation among a plurality of specification items of the product and the component by using the specification data in the specification data storage unit, and of storing the specification-item relation information in a storage unit; and
a display unit of performing a processing of graphically displaying the specification-item relation information in the storage unit on a screen for a user.

2. The product-information management device according to claim 1 comprising
an edition unit of performing a processing of editing the relation among the plurality of specification items in the specification-item relation information displayed on the screen by an input operation of the user, and of updating the specification-item relation information in the storage unit and a display content of the screen in accordance with the edition.

3. The product-information management device according to claim 1,
wherein the calculation unit performs a processing of calculating a relation value α between both of paired specification items as the specification-item relation information and of storing the relation value in the storage unit as relation value data, a processing of calculating an influence value β on the paired specification items and of storing the influence value in the storage unit as influence value data, a processing of setting a related-specification-item group in the plurality of specification items based on the relation value α, and a processing of setting a representative specification item in the related-specification-item group based on the influence value β.

4. The product-information management device according to claim 3,
wherein the calculation unit calculates a correlation coefficient R in paired specification items based on the relation value α.

5. The product-information management device according to claim 3,
wherein the calculation unit calculates a regression coefficient A in regression analysis Y=AX with taking one of paired specification items as an explanatory variable X and taking the other as an explained variable Y based on the influence value β.

6. The product-information management device according to claim 3,
wherein the display unit displays information containing the representative specification item and the related-specification-item group for the plurality of specification items of the product or the component on the screen as list information in a tree form.

7. The product-information management device according to claim 3,
wherein the display unit displays information containing the specification item and the representative related-specification-item group for the plurality of specification items of the product or the component on the screen in a network form in which a link line in accordance with the relation value α connects between nodes each of which is used as each of the specification items.

8. The product-information management device according to claim 7,
wherein, on the screen, a threshold of the relation value α is displayed, the threshold can be variably set by a user, and a specification item having the relation value α equal to or larger than the threshold is displayed so as to be emphasized.

9. A product-information management method for managing information of a product and a component using an information processing of a computation device comprising:
a first processing step of storing specification data containing a specification item of the product and the component and containing a specification value of the specification item in a storage unit;
a second processing step of performing a processing of calculating specification-item relation information representing a relation among a plurality of specification items of the product and the component by using the specification data, and of storing the specification-item relation information in the storage unit; and
a third processing step of performing a processing of graphically displaying the specification-item relation information on a screen for a user.

10. A product-information management program for executing a processing of managing information of a product and a component using an information processing of a computation device comprising:
a first processing of storing specification data containing a specification item of the product and the component and containing a specification value of the specification item in a storage unit;
a second processing of performing a processing of calculating specification-item relation information representing a relation among a plurality of specification items of the product and the component by using the specification data, and of storing the specification-item relation information in the storage unit; and
a third processing of performing a processing of graphically displaying the specification-item relation information on a screen for a user.
